(19) United States
(12) Patent Application Publication
(10) Pub. No.: US 2026/0275098 A1
(43) Pub. Date: Sep. 17, 2026

(54) CHLORINATED VINYL CHLORIDE RESIN COMPOSITION

(71) Applicant: KANEKA CORPORATION, Osaka (JP)

(72) Inventor: Takuya Mitsunaga, Hyogo (JP)

(73) Assignee: KANEKA CORPORATION, Osaka (JP)

(21) Appl. No.: 19/569,701

(22) Filed: Mar. 17, 2026

(30) Foreign Application Priority Data
Mar. 17, 2025 (JP) 2025-042313

(51) Int. Cl. C08L 27/24

(52) U.S. Cl. CPC C08L 27/24; C08L 2207/53

(57) ABSTRACT

A chlorinated vinyl chloride resin composition that is excellent in terms of thermal stability and impact resistance is provided. A resin composition includes a chlorinated vinyl chloride resin and core-shell particles. A content of the core-shell particles is from 0.5 to 20 parts by weight per 100 parts by weight of the chlorinated vinyl chloride resin. Each of the core-shell particle includes a core and a shell layer positioned outside the core. The core is formed from a crosslinked polymer including a (meth)acrylic acid ester compound as a constituent monomer. The shell layer is formed from a shell-forming polymer including a vinyl cyanide compound as a constituent monomer.

### TECHNICAL FIELD

One or more embodiments of the present invention relate to a resin composition including a chlorinated vinyl chloride resin.

### BACKGROUND

A chlorinated vinyl chloride resin is a resin produced by chlorinating a vinyl chloride resin, and is a resin in which the thermal resistance of the vinyl chloride resin is improved by several tens of degrees Celsius while retaining excellent weather resistance, electrical properties, transparency, and so forth possessed by the vinyl chloride resin. Such a chlorinated vinyl chloride resin is, owing to its high thermal resistance, suitably used as a constituent material for components that are continuously exposed to high temperatures (e.g., pipes for high-temperature water and steam pipes), i.e., components for which general vinyl chloride resins are unusable since they soften when continuously exposed to high temperatures.

However, chlorinated vinyl chloride resins, similar to vinyl chloride resins, have insufficient impact resistance. As methods for improving the impact resistance of a chlorinated vinyl chloride resin, Patent Literature 1 discloses blending, into a chlorinated vinyl chloride resin, a copolymer of an alkyl (meth)acrylate monomer component and a diene rubbery polymer as an impact modifier, whereas Patent Literature 2 discloses blending, into a chlorinated vinyl chloride resin, a tin stabilizer, an acid group-containing polymer, and graft copolymer particles having a specific core-shell structure in which a core layer is formed from a crosslinked polymer, the crosslinked polymer being poly(butadiene-styrene).

### PATENT LITERATURE

PTL 1: Japanese Laid-Open Patent Application Publication No. 2014-224176
PTL 2: Japanese Laid-Open Patent Application Publication No. 2022-011316

Since a chlorinated vinyl chloride resin has excellent thermal resistance, it needs to be processed at a higher temperature than in the case of processing a vinyl chloride resin. However, when a chlorinated vinyl chloride resin is exposed to high temperatures for a long period of time, discoloration thereof may occur. Therefore, high thermal stability is also required for a chlorinated vinyl chloride resin.

However, merely blending the graft copolymer disclosed in Patent Literature 1 or 2 into a chlorinated vinyl chloride resin cannot achieve sufficient improvement in the thermal stability of the chlorinated vinyl chloride resin.

### SUMMARY

In view of the above, one or more embodiments of the present invention provide a chlorinated vinyl chloride resin composition that is excellent in terms of thermal stability and impact resistance.

The inventors of one or more embodiments of the present invention have found that the above can be addressed by a resin composition including a chlorinated vinyl chloride resin and specific core-shell particles, thereby arriving at one or more embodiments of the present invention.

Specifically, one or more embodiments of the present invention relate to a resin composition including: a chlorinated vinyl chloride resin; and core-shell particles, wherein: a content of the core-shell particles is from 0.5 to 20 parts by weight per 100 parts by weight of the chlorinated vinyl chloride resin; each core-shell particle includes a core and a shell layer positioned outside the core; the core is formed from a crosslinked polymer including a (meth)acrylic acid ester compound as a constituent monomer; and the shell layer is formed from a shell-forming polymer including a vinyl cyanide compound as a constituent monomer.

One or more embodiments of the present invention make it possible to provide a chlorinated vinyl chloride resin composition that is excellent in terms of thermal stability and impact resistance.

### DETAILED DESCRIPTION

Hereinafter, one or more embodiments of the present invention are described in detail.

A resin composition of the embodiment includes a chlorinated vinyl chloride resin and a specific amount of core-shell particles. Each core-shell particle includes a core and a shell layer positioned outside the core. The core is formed from a crosslinked polymer including a (meth)acrylic acid ester compound as a constituent monomer, and the shell layer is formed from a shell-forming polymer including a vinyl cyanide compound as a constituent monomer.

### (Chlorinated Vinyl Chloride Resin)

The chlorinated vinyl chloride resin is obtained by chlorinating a vinyl chloride resin. Specifically, the chlorinated vinyl chloride resin is, for example, a resin obtained by chlorinating a vinyl chloride homopolymer, or a resin obtained by chlorinating a copolymer containing 80% by weight or greater of vinyl chloride and one or more other monomers copolymerizable with vinyl chloride (e.g., vinyl acetate, vinylidene chloride, ethylene, propylene, acrylonitrile, acrylic acid or an ester thereof, methacrylic acid or an ester thereof, etc.)

The chlorine content in the chlorinated vinyl chloride resin is not particularly limited, but may be about 58 to 72% by weight, and may be about 64 to 68% by weight.

The degree of polymerization of the chlorinated vinyl chloride resin is also not particularly limited, and can be selected depending on a processing method of the resin and an intended use of a molded article of the resin composition.

As the chlorinated vinyl chloride resin, a normal commercially available product can be used. Examples of the commercially available product include KANEKA CPVC H829, H716S, H727, H527, H516A, H547, H536, H305 (trade names, available from KANEKA CORPORATION) and SEKISUI PVC HA-15E, HA-05E, HA-15F, HA-24F, HA-22H, HA-36F, HA-05K, HA-24K, HA-24L, HA-31K, HA-54K (trade names, available from SEKISUI CHEMICAL CO., LTD.)

### (Core-Shell Particles)

Each core-shell particle has a core-shell structure including a core and a shell layer positioned outside the core. In the polymer particle, the core is a polymer layer positioned inside the shell layer. The core may be a single layer, or may include two or more layers having different monomer compositions from each other.

The shell layer is a polymer layer positioned on the surface side of the core-shell particle, and is also referred to as a graft layer. However, the polymers forming the shell layer also include polymers that are not graft-bonded to the core. Although the shell layer is a layer that covers the surface of the core, the shell layer need not cover the entire surface of the core, and it is sufficient that the shell layer covers at least part of the surface of the core.

### (Core)

The core of the core-shell particle is formed from a crosslinked polymer including a (meth)acrylic acid ester compound as a constituent monomer. As a result of the core being formed from the crosslinked polymer, the impact resistance of the chlorinated vinyl chloride resin to which the core-shell particles are added can be improved. Further, as a result of the (meth)acrylic acid ester compound being included as a constituent monomer, thermal stability and processability of the chlorinated vinyl chloride resin to which the core-shell particles are added can be improved. It should be noted that the term “(meth)acrylic” herein collectively refers to acrylic and methacrylic.

The (meth)acrylic acid ester compound is not particularly limited, and examples thereof include: alkyl (meth)acrylates, such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl(meth)acrylate; aromatic ring-containing (meth)acrylates, such as phenoxyethyl (meth)acrylate and benzyl (meth)acrylate; hydroxyalkyl acrylates, such as 2-hydroxyethyl (meth)acrylate and 4-hydroxybutyl (meth)acrylate; glycidyl group-containing (meth)acrylates, such as glycidyl (meth)acrylate and glycidyl alkyl (meth)acrylate; and alkoxyalkyl (meth)acrylates. A single (meth)acrylic acid ester compound may be used alone, or two or more (meth)acrylic acid ester compounds may be used in combination.

The (meth)acrylic acid ester compound may be an alkyl (meth)acrylate, or an alkyl acrylate.

Among monomer components of the crosslinked polymer (specifically, monomer components excluding polyfunctional monomers), the proportion of the (meth)acrylic acid ester may be 50% by weight or greater, 70% by weight or greater, 80% by weight or greater, or 90% by weight or greater, from the viewpoints of thermal stability and processability of the chlorinated vinyl chloride resin to which the core-shell particles are added. The upper limit of the proportion may be 100% by weight or less.

To introduce a crosslinked structure into the crosslinked polymer, for example, a crosslinkable component such as a polyfunctional monomer may be used when polymerizing the monomer components.

Examples of the polyfunctional monomer include: allyl(meth)acrylates; allyl alkyl (meth)acrylates; allyloxyalkyl (meth)acrylates; polyfunctional (meth)acrylates having two or more (meth)acrylic groups, such as polyethylene glycol di(meth)acrylate, butanediol di(meth)acrylate, ethylene glycol di(meth)acrylate, triethylene glycol di(meth)acrylate, and tetraethylene glycol di(meth)acrylate; and diallyl phthalate, triallyl cyanurate, triallyl isocyanurate, divinylbenzene, and so forth. The polyfunctional monomer may be allyl methacrylate, triallyl isocyanurate, butanediol di(meth)acrylate, or divinylbenzene. The polyfunctional monomer may be allyl methacrylate.

The usage amount of the polyfunctional monomer is not particularly limited, and may be within a known range. For example, the usage amount may be from 0.01 to 10 parts by weight, from 0.05 to 5 parts by weight, from 0.1 to 3 parts by weight, or from 0.2 to 2 parts by weight, per 100 parts by weight of the total monomer components of the crosslinked polymer.

The proportion of the core to the entire core-shell particle may be from 50% by weight to 95% by weight, from 60% by weight to 95% by weight, from 70% by weight to 92% by weight, or from 80% by weight to 92% by weight, from the viewpoints of impact resistance and thermal stability.

The core may be a single-layer core formed from a single-composition crosslinked polymer, or may be a multilayer core formed from a plurality of types of crosslinked polymers with different types or amounts of monomers and/or polyfunctional monomers.

The glass transition temperature of the polymer forming the core is not particularly limited. However, in a case where the core has a single-layer structure, the glass transition temperature may be, for example, within the range of −150° C. to 0° C. From the viewpoint of impact resistance, the glass transition temperature may be within the range of −150° C. to −10° C., within the range of −150° C. to −20° C., within the range of −150° C. to −30° C., or within the range of −150° C. to −50° C.

The glass transition temperature of the polymer forming the core can be controlled by changing the types and ratios of monomers forming the polymer. The glass transition temperature can be measured by using a differential scanning calorimeter (DSC). The same applies to glass transition temperatures mentioned below.

### (Multilayer Core)

The core may be a multilayer core including at least two layers including a first core layer and a second core layer positioned outside the first core layer. Each of the first core layer and the second core layer is formed from a crosslinked polymer including a (meth)acrylic acid ester compound as a constituent monomer. Each layer of the multilayer core may be graft-bonded to its adjacent layer.

The (meth)acrylic acid ester compound serving as a constituent monomer of the polymer forming the first core layer (also referred to as a first core forming polymer) may be an alkyl (meth)acrylate compound, an alkyl (meth)acrylate compound having an alkyl group with four or more carbon atoms, an alkyl (meth)acrylate compound having an alkyl group with six or more carbon atoms, an alkyl acrylate compound having an alkyl group with six or more carbon atoms, or 2-ethylhexyl acrylate.

The glass transition temperature of the first core forming polymer is not particularly limited. However, from the viewpoint of impact resistance, the glass transition temperature may be, for example, 0° C. or lower, −30° C. or lower, or −60° C. or lower. Although the lower limit of the glass transition temperature of the first core forming polymer is not particularly limited, the lower limit temperature may be −150° C. or higher, or −120° C. or higher. From the viewpoint of impact resistance, the glass transition temperature of the first core forming polymer may be equal to or lower than the glass transition temperature of a below-described second core forming polymer.

In the polymers forming the multilayer core, the proportion of the first core forming polymer may be from 5 to 90% by weight, from 10 to 70% by weight, or from 15 to 50% by weight.

The (meth)acrylic acid ester compound serving as a constituent monomer of the polymer forming the second core layer (also referred to as a second core forming polymer) may be an alkyl (meth)acrylate compound, an alkyl (meth)acrylate compound having an alkyl group with three or more carbon atoms, an alkyl (meth)acrylate compound having an alkyl group with four or more carbon atoms, an alkyl acrylate compound having an alkyl group with four or more carbon atoms, or butyl acrylate.

The glass transition temperature of the second core forming polymer is not particularly limited. However, from the viewpoint of impact resistance, the glass transition temperature may be, for example, 0° C. or lower, −25° C. or lower, or −50° C. or lower. Although the lower limit of the glass transition temperature of the second core forming polymer is not particularly limited, the lower limit temperature may be −150° C. or higher, or −120° C. or higher.

In the polymers forming the multilayer core, the proportion of the second core forming polymer may be from 10 to 95% by weight, from 30 to 90% by weight, or from 50 to 85% by weight.

The multilayer core may include only the first core layer and the second core layer if the entire multilayer core is formed from a crosslinked polymer including a (meth)acrylic acid ester compound as a constituent monomer. The multilayer core may further include an additional layer in addition to the first core layer and the second core layer. It should be noted that the additional layer included in addition to the first core layer and the second core layer is not limited to a single layer, but may be multiple layers.

### (Shell Layer)

The shell layer is formed from a shell-forming polymer including a vinyl cyanide compound as a constituent monomer. As a result of the shell-forming polymer including a vinyl cyanide compound as a constituent monomer, the affinity between the core-shell particles and the chlorinated vinyl chloride resin serving as a matrix is enhanced, and thereby the impact resistance of the chlorinated vinyl chloride resin to which the core-shell particles are added can be improved.

Examples of the vinyl cyanide compound as a constituent monomer of the shell-forming polymer include acrylonitrile and methacrylonitrile. Acrylonitrile is particularly preferred.

The proportion of the vinyl cyanide compound monomer in the total constituent monomers of the shell-forming polymer is not particularly limited. However, from the viewpoint of compatibility, the proportion may be 5% by weight or greater, 10% by weight or greater, or 20% by weight. The upper limit of the proportion is also not particularly limited. However, from the viewpoint of polymerization stability of the shell-forming polymer, the upper limit of the proportion may be 50% by weight or less, and may be 40% by weight or less.

The shell-forming polymer is a vinyl polymer. A vinyl polymer is obtained by homopolymerization or copolymerization of a vinyl monomer(s).

The monomers forming the shell-forming polymer may include monomers other than the vinyl cyanide compound. Examples of such monomers include aromatic vinyl compounds, (meth)acrylic acid ester compounds, and ethylenically unsaturated carboxylic acids. Among these, from the viewpoint of polymerization stability with the vinyl cyanide compound units, at least one selected from the group consisting of aromatic vinyl compounds and (meth)acrylic acid ester compounds is preferred, and aromatic vinyl compounds are more preferred.

The aromatic vinyl compounds are not particularly limited, and examples thereof include: unsubstituted vinyl aromatic compounds, such as styrene and 2-vinylnaphthalene; substituted vinyl aromatic compounds, such as α-methylstyrene; ring-alkylated vinyl aromatic compounds, such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinyl aromatic compounds, such as 4-methoxystyrene and 4-ethoxystyrene; ring-halogenated vinyl aromatic compounds, such as 2-chlorostyrene and 3-chlorostyrene; ring-ester-substituted vinyl aromatic compounds, such as 4-acetoxystyrene; and ring-hydroxylated vinyl aromatic compounds, such as 4-hydroxystyrene. Among these, substituted or unsubstituted styrene is preferred; styrene and/or α-methylstyrene are more preferred; and styrene is particularly preferred. A single aromatic vinyl compound may be used alone, or two or more aromatic vinyl compounds may be used in combination.

The (meth)acrylic acid ester compounds are not particularly limited, and examples thereof include the same (meth)acrylic acid ester compounds as those each exemplified as a constituent monomer of the core. A single (meth)acrylic acid ester compound may be used alone, or two or more (meth)acrylic acid ester compounds may be used in combination.

In particular, the (meth)acrylic acid ester compound used as a constituent monomer of the shell-forming polymer may be an alkyl (meth)acrylate.

The number of carbon atoms of the alkyl group of the alkyl (meth)acrylate is not particularly limited, but may be from 1 to 6, from 1 to 3, or 1 or 2.

The total proportion of the aromatic vinyl compound monomer and the (meth)acrylic acid ester compound monomer to all the constituent monomers of the shell-forming polymer (specifically, to all the monomer components excluding the vinyl cyanide compound) is not particularly limited. However, from the viewpoint of polymerization stability of the shell-forming polymer, the total proportion may be 50% by weight or greater, or 60% by weight or greater. The upper limit of the total proportion is also not particularly limited, but may be 100% by weight or less, and may be 95% by weight or less.

The proportion of the shell-forming polymer to the entire core-shell particle is not particularly limited. However, from the viewpoint of impact resistance, the proportion may be from 5 to 50% by weight, from 5 to 40% by weight, or from 8 to 30% by weight.

The shell layer may be a non-crosslinked polymer from the viewpoint of enhancing compatibility with the chlorinated vinyl chloride resin and promoting uniform dispersion of the core-shell particles in the chlorinated vinyl chloride resin composition. The non-crosslinked polymer refers to a polymer that includes neither a crosslinked structure nor a structural unit derived from a polyfunctional monomer and that does not correspond to a rubber elastic body such as acrylic rubber.

From the viewpoint of imparting excellent impact resistance to the chlorinated vinyl chloride resin, the core-shell particles may have a volume mean particle diameter of 100 nm or greater, 120 nm or greater, or 140 nm or greater. The upper limit value of the volume mean particle diameter of the core-shell particles is not particularly limited. However, from the viewpoint of productivity, the upper limit value may be, for example, 1,000 nm or less, or 700 nm or less. Further, from the viewpoint of granulation property and impact resistance, the upper limit value may be 600 nm or less, or 500 nm or less.

The volume mean particle diameter of the core-shell particles is, as described in Examples below, a value measured in a latex state of the core-shell particles by using a particle diameter measuring apparatus. The particle diameter of the core-shell particles can be controlled by, for example, charged amounts of the respective monomers forming the core-forming polymer, a charged amount of the core-forming polymer during formation of the shell portion, types and amounts of a polymerization initiator, a chain transfer agent, a redox agent, an emulsifier, and so forth used in polymerization, a polymerization temperature, a polymerization time, etc.

The content of the core-shell particles in the chlorinated vinyl chloride resin composition according to the present embodiment may be from 0.5 to 20 parts by weight, from 3 to 15 parts by weight, or from 4 to 12 parts by weight, per 100 parts by weight of the chlorinated vinyl chloride resin. In a case where the content exceeds 20 parts by weight, thermal resistance may be impaired, whereas in a case where the content is less than 0.5 parts by weight, impact resistance may not be sufficiently improved.

In the core-forming polymer of the core-shell particles, the content of butadiene as a constituent monomer may be as low as possible. The core-forming polymer of the core-shell particles may contain no butadiene as a constituent monomer. Specifically, the proportion of butadiene monomer units to all the constituent monomers of the polymer of the core-shell particles may be, for example, 10% by weight or less, 5% by weight or less, or 0% by weight. Accordingly, the thermal stability of the core-shell particles is enhanced, and the dynamic thermal stability of the chlorinated vinyl chloride resin composition to which the core-shell particles are added can be improved. By improving the dynamic thermal stability, the torque during melt kneading can be kept low, thereby reducing the load on a kneader and avoiding an unnecessary temperature increase and the risk of combustion, which leads to improvement in processability.

### (Method for Producing Core-Shell Particles)

A method for producing the core-shell particles is not particularly limited. For example, emulsion polymerization, miniemulsion polymerization, microemulsion polymerization, and emulsifier-free (soap-free) emulsion polymerization may be used.

Emulsifiers that can be used in emulsion polymerization are not particularly limited, and examples thereof include anionic surfactants, non-ionic surfactants, cationic surfactants, and amphoteric surfactants. The emulsifiers may be used together with dispersants, such as polyvinyl alcohol, alkyl-substituted cellulose, polyvinylpyrrolidone, and polyacrylic acid derivatives.

Among the above emulsifiers, the anionic surfactants are not particularly limited, and examples thereof include the following compounds: fatty acid soaps, such as potassium laurate, potassium coconut fatty acids, potassium myristate, potassium oleate, potassium oleate diethanolamine salts, sodium oleate, potassium palmitate, potassium stearate, sodium stearate, mixed fatty acid sodium soaps, semi-hardened tallow fatty acid sodium soaps, and castor oil potassium soaps; alkyl sulfate ester salts, such as sodium dodecyl sulfate, sodium higher alcohol sulfate, triethanolamine dodecyl sulfate, ammonium dodecyl sulfate, sodium polyoxyethylene alkyl ether sulfate, triethanolamine polyoxyethylene alkyl ether sulfate, sodium polyoxyethylene alkylphenyl ether sulfate, and sodium 2-ethylhexyl sulfate; sodium alkylbenzene sulfonates, such as sodium dodecylbenzenesulfonate; sodium dialkyl sulfosuccinates, such as sodium di-2-ethylhexyl sulfosuccinate; sodium alkylnaphthalene sulfonates; sodium alkyl diphenyl ether disulfonates; potassium alkyl phosphate salts; phosphate ester salts, such as sodium polyoxyethylene lauryl ether phosphate; sodium salts of naphthalene sulfonic acid-formalin condensates; polycarboxylic acid-type polymeric anions; sodium acyl(tallow) methyl taurate; sodium acyl (coconut) methyl taurate; sodium cocoyl isethionate; sodium α-sulfo fatty acid ester salts; sodium amide ether sulfonates; oleyl sarcosine; sodium lauroyl sarcosinate; and rosin acid soaps.

Among the above emulsifiers, the non-ionic surfactants are not particularly limited, and examples thereof include the following compounds: polyoxyethylene alkylaryl ethers or polyoxyethylene alkyl ethers, such as polyoxyethylene nonylphenyl ether, polyoxyethylene oleyl ether, and polyoxyethylene lauryl ether; polyoxyethylene sorbitan esters, such as polyoxyethylene sorbitan monolaurate and polyoxyethylene sorbitan monostearate; polyoxyethylene fatty acid esters, such as polyethylene glycol monolaurate, polyethylene glycol monostearate, and polyethylene glycol monooleate; and oxyethylene/oxypropylene block copolymers.

Among the above emulsifiers, the cationic surfactants are not particularly limited, and examples thereof include the following compounds: alkylamine salts, such as coconut amine acetate, stearylamine acetate, octadecylamine acetate, and tetradecylamine acetate; and quaternary ammonium salts, such as lauryltrimethylammonium chloride, stearyltrimethylammonium chloride, cetyltrimethylammonium chloride, distearyldimethylammonium chloride, alkylbenzyldimethylammonium chloride, hexadecyltrimethylammonium chloride, and behenyltrimethylammonium chloride.

Among the above emulsifiers, the amphoteric surfactants are not particularly limited, and examples thereof include the following compounds: alkyl betaines, such as lauryl betaine, stearyl betaine, and dimethyl lauryl betaine; sodium lauryldiaminoethyl glycine; amide betaines; imidazolines; and lauryl carboxymethyl hydroxyethyl imidazolinium betaine.

One of these emulsifiers may be used alone, or two or more of these emulsifiers may be used in combination. As the emulsifier, sodium dialkyl sulfosuccinate or a surfactant having an oxyethylene structure is preferred, and sodium polyoxyethylene lauryl ether phosphate is particularly preferred. The mean particle diameter of the polymer particles can be controlled by adjusting the usage amount(s) of the emulsifier(s).

In the case of adopting emulsion polymerization, a known polymerization initiator can be used, such as 2,2′-azobisisobutyronitrile, hydrogen peroxide, potassium persulfate, or ammonium persulfate, as a thermally decomposable initiator.

A redox-type initiator can also be used. In the redox-type initiator, for example, the following may be used in combination: an organic peroxide, such as t-butyl peroxyisopropyl carbonate, p-menthane hydroperoxide, cumene hydroperoxide, dicumyl peroxide, t-butyl hydroperoxide, di-t-butyl peroxide, or t-hexyl peroxide; an inorganic peroxide, such as hydrogen peroxide, potassium persulfate, or ammonium persulfate; a reductant, such as sodium formaldehyde sulfoxylate or glucose as necessary; a transition metal salt, such as iron (II) sulfate as necessary; a chelating agent, such as disodium ethylenediaminetetraacetate as necessary; and a phosphorus-containing compound, such as sodium pyrophosphate as necessary.

In the case of using such a redox-type initiator, polymerization can be performed even at a low temperature at which the aforementioned peroxides do not substantially undergo thermal decomposition. Accordingly, the polymerization temperature can be set over a wide range, which is preferred. In particular, it is preferred to use an organic peroxide such as cumene hydroperoxide, dicumyl peroxide, or t-butyl hydroperoxide as the redox-type initiator. The usage amount of the initiator, and in the case of using a redox-type initiator, the usage amounts of the reductant, transition metal salt, chelating agent, and so forth, can be within known ranges. When polymerizing a monomer having two or more radical-polymerizable double bonds, a known chain transfer agent can be used within a known range. Additionally, a surfactant can be used, also within a known range.

As a solvent used in emulsion polymerization, any solvent that allows the emulsion polymerization to progress stably may be used. For example, water can be suitably used.

The temperature during emulsion polymerization is not particularly limited, so long as the emulsifier is uniformly dissolved in the solvent. For example, the temperature may be from 40 to 75° C., from 45 to 70° C., or from 49 to 65° C.

In the case of producing the above-described core-shell particles, for example, the latex of the core-shell particles may be dried and thereby converted into a particulate form.

For example, one or more coagulants selected from the group consisting of acids and salts are added to the latex of the core-shell particles to cause coagulation. The coagulated material is subjected to heat treatment, for example, at a temperature of 40° C. to 110° C., followed by washing, dewatering, drying, and sieving through a sieve of a predetermined size. In this manner, graft copolymer particles can be obtained.

Examples of the coagulants include calcium chloride and hydrochloric acid, and these salts may be used in the form of an aqueous solution.

Examples of a method for the above drying include spray drying, standing drying, and vacuum drying.

### (Additives)

The resin composition of the present embodiment may contain, in addition to the chlorinated vinyl chloride resin and the core-shell particles, additives as necessary, such as a stabilizer, a lubricant, a processing aid, a colorant such as a pigment or dye, and a filler.

### (Stabilizer)

As the stabilizer, any of those known to be added to vinyl chloride resins or chlorinated vinyl chloride resins can be used. Examples of the stabilizer include a heat stabilizer, a light stabilizer, and an ultraviolet absorber.

Examples of the heat stabilizer include an organotin stabilizer, a lead stabilizer, a calcium-zinc stabilizer, a barium-zinc stabilizer, and a barium-cadmium stabilizer. One of these stabilizers may be used alone, or two or more of these stabilizers may be used in combination.

The organotin stabilizer is an additive that is excellent in terms of compatibility with the chlorinated vinyl chloride resin and that improves the thermal stability of the resin during processing. The organotin stabilizer is not particularly limited, and examples thereof include diorganotin oxides, diorganotin sulfides, methyltin mercaptide stabilizers, butyltin mercaptide stabilizers, octyltin mercaptide stabilizers, butyltin maleate stabilizers, and octyltin maleate stabilizers. Among these, a butyltin mercaptide stabilizer is preferred because of its strong effect in improving the thermal stability and processability of the chlorinated vinyl chloride resin. From the viewpoint of safety, a methyltin mercaptide stabilizer is preferred.

The content of the tin stabilizer in the resin composition may be from 0.5 to 5 parts by weight, from 1 to 4.5 parts by weight, or from 2 to 4 parts by weight, per 100 parts by weight of the chlorinated vinyl chloride resin. By blending 0.5 to 5 parts by weight of the tin stabilizer, the thermal stability of the chlorinated vinyl chloride resin can be improved without substantially impairing the properties of the chlorinated vinyl chloride resin.

### (Lubricant)

The lubricant is not particularly limited, and examples thereof include butyl stearate, lauryl alcohol, stearyl alcohol, epoxidized soybean oil, glyceryl monostearate, stearic acid, bisamides, paraffin wax, polyolefin wax, ester wax, and montan wax. One of these lubricants may be used alone, or two or more of these lubricants may be used in combination.

### (Processing Aid)

The processing aid is not particularly limited, and examples thereof include acrylic processing aids, such as an alkyl acrylate-alkyl methacrylate copolymer having a weight-average molecular weight of 10,000 to 1,000,000. The acrylic processing aids are not particularly limited, and examples thereof include n-butyl acrylate-methyl methacrylate copolymers and 2-ethylhexyl acrylate-methyl methacrylate-butyl methacrylate copolymers. One of these processing aids may be used alone, or two or more of these processing aids may be used in combination.

### (Colorant)

Examples of the colorant include pigments and dyes. The pigments are not particularly limited, and examples thereof include: inorganic pigments, such as white pigments like titanium dioxide and black pigments like carbon black; and organic pigments, such as disazo yellow and phthalocyanine blue. Examples of the dyes include natural dyes and synthetic dyes.

The chlorinated vinyl chloride resin composition according to the present embodiment can be produced by mixing the chlorinated vinyl chloride resin and the core-shell particles together. The above-described additives may be added to the chlorinated vinyl chloride resin composition as necessary. Also in the case of including the additives, the chlorinated vinyl chloride resin composition can be produced by mixing the chlorinated vinyl chloride resin, the core-shell particles, and the additives together. It is also possible to produce the chlorinated vinyl chloride resin composition by a method including: preparing a composition including the chlorinated vinyl chloride resin and the additives; and then mixing the core-shell particles into the prepared composition.

In the mixing, by using a mixer such as a Henschel mixer or ribbon blender, the chlorinated vinyl chloride resin composition in which the components are uniformly dispersed can be obtained.

### (Molded Article)

The chlorinated vinyl chloride resin composition according to the present embodiment can be molded into a molded article in a desired shape by subjecting the composition to a molding process using a processing machine such as a mixing roll, an injection molding machine, or an extruder depending on its intended use.

The use application of the molded article is not particularly limited, and examples thereof include fire sprinkler pipes, industrial heat-resistant pipes, hot water supply pipes, outdoor air-conditioning duct covers, hot water supply connecting parts, drainage connecting parts, electric power cable connecting parts, transparent joints, heat-resistant industrial plates, joints, heat-resistant flanges, and so forth.

The following items each indicate a preferred mode of the present disclosure. The present invention is not limited to the following items.

[Item 1]

A resin composition including: a chlorinated vinyl chloride resin; and core-shell particles, wherein: a content of the core-shell particles is from 0.5 to 20 parts by weight per 100 parts by weight of the chlorinated vinyl chloride resin; each core-shell particle includes a core and a shell layer positioned outside the core; the core is formed from a crosslinked polymer including a (meth)acrylic acid ester compound as a constituent monomer; and the shell layer is formed from a shell-forming polymer including a vinyl cyanide compound as a constituent monomer.

[Item 2]

The resin composition according to item 1, wherein a proportion of the vinyl cyanide compound units in the shell-forming polymer is 5% by weight or greater.

[Item 3]

The resin composition according to item 1 or 2, wherein the shell-forming polymer further includes, as a constituent monomer, at least one selected from the group consisting of aromatic vinyl compounds and (meth)acrylic acid ester compounds.

[Item 4]

The resin composition according to any one of items 1 to 3, wherein a proportion of the core to the entire core-shell particle is from 50% by weight to 95% by weight.

[Item 5]

The resin composition according to any one of items 1 to 4, wherein a volume mean particle diameter of the core-shell particles is from 100 nm to 1,000 nm.

[Item 6]

A molded article obtained by molding the resin composition according to any one of items 1 to 5.

### EXAMPLES

Hereinafter, one or more embodiments of the present invention are more specifically described with reference to Examples, but the present invention is not limited to these Examples. In the description below, the terms “part” and “%” mean “parts by weight” and “% by weight” unless specified otherwise.

### Examples 1

### (Formation of Core Portion)

Into an 8 L polymerizer, 180 parts of deionized water and 0.0875 parts of sodium lauryl sulfate were charged. The internal temperature of the polymerizer was raised to 40° C., and nitrogen was flowed into the polymerizer.

A mixture of 13.5 parts of 2-ethylhexyl acrylate, 0.07 parts of allyl methacrylate, and 0.0042 parts of cumene hydroperoxide was charged into the polymerizer. Then, 0.007 parts of a mixed solution prepared by dissolving disodium ethylenediaminetetraacetate and ferrous sulfate in deionized water at a mixture ratio of 4:1 to a concentration of 0.1%, and 0.2 parts of sodium formaldehyde sulfoxylate, were charged into the polymerizer, thereby initiating first-stage polymerization.

After 60 minutes have elapsed from the start of the polymerization, a mixture of 76.5 parts of butyl acrylate, 0.38 parts of allyl methacrylate, and 0.025 parts of cumene hydroperoxide was added over 300 minutes to continuously perform second-stage polymerization. After confirming that the polymerization conversion rate exceeded 97%, a core-forming polymer was obtained.

### (Formation of Shell Portion)

Next, the internal temperature of the polymerizer was raised to 45° C.; 0.02 parts of potassium persulfate was charged thereinto; and a mixture of 7 parts of styrene and 3 parts of acrylonitrile was added over 40 minutes. Then, after 60 minutes have elapsed, the polymerization was ended, and core-shell polymer particles having a volume mean particle diameter of 200 nm were obtained with a conversion rate of 100%.

The volume mean particle diameter of the core-shell polymer was measured by using a nanoparticle measurement device NANOTRAC WAVE available from Microtrac. The measurement results are shown in Table 1.

### (Formation of Core-Shell Particulate Material)

A 25% aqueous calcium chloride solution was added as a coagulant to the obtained latex of the core-shell polymer particles to coagulate the core-shell polymer particles. The coagulated product was washed with water, dewatered, and dried to obtain a particulate material of the core-shell polymer particles.

### (Preparation of Each Test Piece (of Chlorinated Vinyl Chloride Resin Composition))

Into a Henschel mixer (SMG-20 available from Kawada Manufacturing Co., Ltd.), 100 parts of CPVC (“Heat-resistant Kanevinyl H829” available from Kaneka Corporation; refractive index 1.550) as the chlorinated vinyl chloride resin, 2.5 parts of a methyltin mercaptide stabilizer, 3 parts of a lubricant (a mixture of an ester wax and a polyethylene wax), 1 part of a processing aid (“PA-101” available from Kaneka Corporation), and 2.5 parts of titanium dioxide were charged. The mixture was heated to 120° C. while being stirred, and then cooled to a room temperature to obtain a compound (109 parts).

An amount of the particulate material of the core-shell polymer particles corresponding to 6 parts per 100 parts of CPVC was added to and mixed with the compound. The mixture was kneaded for five minutes at 195° C. by using two rolls (8-inch mixing rolls available from Nippon Roll Manufacturing Co., Ltd.) to obtain a sheet.” The sheet obtained from the roll kneading was used as a sample for a thermal stability test described below.

Thereafter, the sheet was pressed with a heat press machine (37-ton press available from Shinto Metal Industries, Ltd.) at 200° C. under a pressure of 100 kgf/cm² for 10 minutes, thereby preparing a test piece (12.7 mm×63.5 mm×3.2 mm in thickness) for an Izod impact strength test. Table 1 shows physical property evaluation results.

### (Evaluation of Impact Strength)

The Izod notched impact strength of the test piece for the Izod impact strength test was measured at 23° C. in accordance with JIS K-7110, and the impact strength was evaluated.

### (Evaluation of Static Thermal Stability: Oven Test)

The sheet obtained from the roll kneading was cut into a 5 cm×3 cm sample, which was set in a Geer-type aging tester (available from YASUDA SEIKI SEISAKUSHO, LTD.). The sample was subjected to conditions of a rotation speed of 7.5 rpm and a temperature of 200° C., and was taken out from the tester every 10 minutes for visual inspection to check the presence or absence of blackening. The time required until blackening occurred (i.e., discoloration time) was measured to evaluate static thermal stability.

### (Evaluation of Dynamic Thermal Stability: Kneading Test)

A CPVC compound and a particulate material of core-shell polymer particles were mixed in the parts by weight shown in Table 1, and 65 g of the resulting composition was charged into the chamber of a roller mixer of Labo Plastomill Roller Mixer R60 (4C150, available from Toyo Seiki Seisaku-Sho, Ltd.), with the chamber being stably heated to 190° C. Subsequently, the rollers were rotated at a rotation speed of 50 rpm to knead the CPVC compound, and the value of the torque applied to the rollers was measured. The time at which a variation in the torque value from the minimum torque value after the torque value had reached a steady state exceeded 10% was defined as a decomposition start time, and this time was used to evaluate dynamic thermal stability.

TABLE 1

| | | | | | | | | | | | | Comparative | | | | |
|---|---|---|---|---|---|---|---|---|---|---|---|---|---|---|---|---|
| | | | | Examples | | | | | | | | Examples | | | | |
| | | | | 1 | 2 | 3 | 4 | 5 | 6 | 7 | 8 | 1 | 2 | 3 | 4 | 5 |
| Core | 1st core | Proportion (wt %) in core- | 2EHA | 13.5 | 13.5 | 13.5 | 13.5 | 13.5 | 13.5 | 13.5 | 13.5 | 13.5 | 13.5 | 13.5 | 13.5 | |
| | layer | shell polymer (excluding | | | | | | | | | | | | | | |
| | (1st stage) | polyfunctional monomers | | | | | | | | | | | | | | |
| | | ALMA | | 0.07 | 0.07 | 0.07 | 0.07 | 0.07 | 0.07 | 0.07 | 0.07 | 0.07 | 0.07 | 0.07 | 0.07 | |
| | 2nd core | Proportion (wt %) in core- | BA | 76.5 | 76.5 | 76.5 | 76.5 | 76.5 | 76.5 | 76.5 | 76.5 | 76.5 | 76.5 | 76.5 | 76.5 | |
| | layer | shell polymer (excluding | | | | | | | | | | | | | | |
| | (2nd stage) | polyfunctional monomers) | | | | | | | | | | | | | | |

| | | | | | | | | | | | | |
|---|---|---|---|---|---|---|---|---|---|---|---|---|
| ALMA | 0.38 | 0.38 | 0.38 | 0.38 | 0.38 | 0.38 | 0.38 | 0.38 | 0.38 | 0.38 | 0.38 | 0.38 |

| | | | | | | | | | | | | | | |
|---|---|---|---|---|---|---|---|---|---|---|---|---|---|---|
| Shell layer | Proportion (wt %) in core- | ST | 7 | 7 | 8 | 8 | 9 | 9 | 6 | 6 | 10 | 10 | | |
| | shell polymer (excluding | AN | 3 | 3 | 2 | 2 | 1 | 1 | 3 | 3 | | | | |
| | polyfunctional | MMA | | | | | | | 1 | | | | 10 | 10 |
| | monomers) | BA | | | | | | | | 1 | | | | |

| Volume mean particle diameter (nm) of | | 200 | 200 | 200 | 200 | 200 | 200 | 200 | 200 | 200 | 200 | 200 | 200 | |
|---|---|---|---|---|---|---|---|---|---|---|---|---|---|---|
| core-shell polymer | | | | | | | | | | | | | | |
| Resin | CPVC compound | 109 | 109 | 109 | 109 | 109 | 109 | 109 | 109 | 109 | 109 | 109 | 109 | 109 |
| Composition | (parts by weight) | | | | | | | | | | | | | |
| | core-shell polymer | 6 | 8 | 6 | 8 | 6 | 8 | 8 | 8 | 6 | 8 | 6 | 8 | |
| | (parts by weight) | | | | | | | | | | | | | |
| | MBS (parts by weight) | | | | | | | | | | | | | 8 |

| | | | | | | | | | | | | | |
|---|---|---|---|---|---|---|---|---|---|---|---|---|---|
| Evaluation of impact strength: | 62 | 72 | 61 | 67 | 60 | 63 | 72 | 72 | 52 | 57 | 54 | 58 | 72 |
| 23° C. Izod strength (kJ/m²) | | | | | | | | | | | | | |
| Static thermal stability: Oven test (min) | 100 | 100 | 100 | 100 | 100 | 100 | 100 | 100 | 100 | 100 | 100 | 100 | 60 |
| Dynamic thermal stability: kneading test (min) | >30 | >30 | >30 | >30 | >30 | >30 | >30 | >30 | >30 | >30 | >30 | >30 | 15 |

Abbreviations in Table 1 are as follows.
2EHA: 2-ethylhexyl acrylate
ALMA: allyl methacrylate
BA: butyl acrylate
ST: styrene
AN: acrylonitrile
MMA: methyl methacrylate

### Examples 2 to 8 and Comparative Examples 1 to 4

In each of Examples 2 to 8 and Comparative Examples 1 to 4, a particulate material of core-shell polymer particles was obtained in the same manner as in Example 1 except that the composition of the shell layer was varied in accordance with Table 1; a test piece was prepared with additive amounts shown in Table 1; and impact strength evaluation, static thermal stability evaluation, and dynamic thermal stability evaluation were performed on the test piece.

### Comparative Example 5

In Comparative Example 5, a test piece was prepared in the same manner as in Example 1 except that, as the core-shell polymer, MBS particles (methyl methacrylate-butadiene-styrene copolymer particles; “B-564” available from Kaneka Corporation) were used in accordance with Table 1, and impact strength evaluation, static thermal stability evaluation, and dynamic thermal stability evaluation were performed on the test piece.

As shown in Table 1, the chlorinated vinyl chloride resin compositions obtained in Examples 1 to 8 each exhibit a longer discoloration time, a longer decomposition start time, better static thermal stability, better dynamic thermal stability, and higher impact strength than the chlorinated vinyl chloride resin compositions obtained in Comparative Examples. Accordingly, it is understood that the chlorinated vinyl chloride resin compositions obtained in Examples 1 to 8 are excellent in terms of both thermal stability and impact resistance. From the dynamic thermal stability evaluation results, it is understood that the chlorinated vinyl chloride resin compositions obtained in Examples 1 to 8 are also excellent in terms of processability.

It is understood that the chlorinated vinyl chloride resin compositions of Comparative Examples 1 to 4, in which the core-shell particles whose shell layer does not include a vinyl cyanide compound as a constituent monomer are used, are all inferior in terms of impact resistance.

The chlorinated vinyl chloride resin composition of Comparative Example 5, in which MBS particles are used instead of the specific core-shell particles, exhibits a shorter discoloration time, a shorter decomposition start time, insufficient static thermal stability, and insufficient dynamic thermal stability, and it is understood that the chlorinated vinyl chloride resin composition of Comparative Example 5 is inferior in terms of thermal stability. From the dynamic thermal stability evaluation results, it is understood that the processability of the chlorinated vinyl chloride resin composition of Comparative Example 5 is also insufficient.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A resin composition comprising:
a chlorinated vinyl chloride resin; and
core-shell particles,
wherein:
a content of the core-shell particles is from 0.5 to 20 parts by weight per 100 parts by weight of the chlorinated vinyl chloride resin;
each of the core-shell particles comprises a core and a shell layer positioned outside the core;
the core is formed from a crosslinked polymer comprising a (meth)acrylic acid ester compound as a constituent monomer; and
the shell layer is formed from a shell-forming polymer comprising a vinyl cyanide compound as a constituent monomer.

2. The resin composition according to claim 1, wherein a proportion of the vinyl cyanide compound in the shell-forming polymer is 5% by weight or greater.

3. The resin composition according to claim 1, wherein the shell-forming polymer further comprises, as a constituent monomer, at least one selected from the group consisting of aromatic vinyl compounds and (meth)acrylic acid ester compounds.

4. The resin composition according to claim 1, wherein a proportion of the core to an entire core-shell particle is from 50% by weight to 95% by weight.

5. The resin composition according to claim 1, wherein a volume mean particle diameter of the core-shell particles is from 100 nm to 1,000 nm.

6. A molded article obtained by molding the resin composition according to claim 1.
